(19) United States
(12) Patent Application Publication
(10) Pub. No.: US 2022/0299325 A1
(43) Pub. Date: Sep. 22, 2022

(54) METHOD FOR HANDLING TRAFFIC SITUATIONS WITH RESTRICTED PASSAGE GEOMETRY AND TRANSPORTATION VEHICLE

(71) Applicant: VOLKSWAGEN AKTIENGESELLSCHAFT, Wolfsburg (DE)

(72) Inventors: Jörg VOLTMER, Hannover (DE); Hendrik HOPPMANN, Braunschweig (DE); Janis KÖSTERMANN, Berlin (DE)

(21) Appl. No.: 17/655,668

(22) Filed: Mar. 21, 2022

(30) Foreign Application Priority Data
Mar. 22, 2021 (DE) 10 2021 202 766.0

(51) Int. Cl. G01C 21/34; G01C 21/36

(52) U.S. Cl. CPC G01C 21/3461; G01C 21/3492; G01C 21/3605

(57) ABSTRACT

A method of a transportation vehicle for environment detection in traffic situations with restricted passage geometry. The method includes identifying a restricted passage geometry from at least one detected sensor value relating to the vehicle surroundings; taking the sensor value as a basis for determining an extent of the restricted passage geometry and a position of the restricted passage geometry; transmitting a message to at least one further transportation vehicle, a server and/or a roadside unit; and generating the message based on the determined extent and position of the restricted passage geometry. A further method of a transportation vehicle for vehicle control in traffic situations with restricted passage geometry includes receiving the message and generating a report and output, which report is based on a comparison of the extent of the restricted passage geometry with dimensions of the transportation vehicle. Also disclosed is a transportation vehicle to carry out the methods.

### PRIORITY CLAIM

This patent application claims priority to German Patent Application No. 10 2021 202 766.0, filed 22 Mar. 2021, the disclosure of which is incorporated herein by reference in its entirety.

### SUMMARY

Illustrative embodiments relate to a method for handling traffic situations with restricted passage geometry. Furthermore, illustrative embodiments relate to a transportation vehicle designed to carry out at least part of the disclosed method.

### BRIEF DESCRIPTION OF THE DRAWINGS

Disclosed embodiments are explained below with reference to the associated drawings, in which:

FIG. 1 shows a schematic flowchart for an illustrative implementation of a disclosed method for environment detection in traffic situations with restricted passage geometry;

FIG. 2 shows a schematic flowchart for an illustrative implementation of a disclosed method for transportation vehicle control in traffic situations with restricted passage geometry;

FIG. 3 shows a schematic depiction of an illustrative embodiment of a transportation vehicle;

FIG. 4 shows detecting, identifying, and determining an illustrative implementation of a disclosed method for environment detection;

FIG. 5 shows determining, generating and transmitting an illustrative implementation of a disclosed method for environment detection;

FIG. 6 shows a pictorial representation of an overview of restricted passage geometries in the surroundings, and

FIG. 7 shows outputting an illustrative implementation of a disclosed method.

### DETAILED DESCRIPTION

In road traffic, it is often possible for transportation vehicles to pass only with restrictions in respect of the vehicle geometry. When travelling through tunnels, narrow roads or parking garages, a passage height or width is often limited. Today, signs usually point out these restrictions. The signs are usually installed only shortly before the obstacle, however, and may moreover be overlooked or concealed. In a traffic situation, the driver is thus often required to assess in a matter of seconds whether or not the measurements of his transportation vehicle permit it to pass. Methods for identifying restricted passage geometries and comparing them with transportation vehicle dimensions are known from DE 10 2014 221 895 A1, DE 10 2016 202 361 A1 and DE 10 2018 206 667 A1.

However, the driver does not necessarily know the relevant dimensions of his transportation vehicle in a rush. Drivers of rented or borrowed transportation vehicles and drivers who use car sharing often cause accidents on account of an incorrect assessment of the measurements. Even for transportation vehicle owners, though, it is often not easy to assess the dimensions, which are dependent on many factors and are variable.

The height of a transportation vehicle is variable, for example, as a result of roof or tailgate structures or adjustable chassis. The width is specified without exterior mirrors in transportation vehicle paperwork. The real transportation vehicle width with exterior mirrors is therefore difficult to estimate. In this case, the width varies depending on the position of the mirrors, which may be in a folded-out or folded-in state, or if, for example, additional trailer mirrors have been installed. Moreover, trailers can influence the measurements of a transportation vehicle considerably. A method for determining current transportation vehicle dimensions is known from DE 10 2019 205 166 A1.

The disclosed embodiments enhance and overcome the prior art or at least reduce the challenges that arise therefrom and provide an improved method for handling traffic situations with restricted passage geometry.

At least one disclosed embodiment relates to a method of a transportation vehicle for environment detection in traffic situations with restricted passage geometry. A transportation vehicle within the context of this disclosure may be a passenger car or truck with an internal combustion, electric or hybrid engine. A restricted passage geometry within the context of this disclosure may be a structural or natural condition in an environment of the transportation vehicle that allows only transportation vehicles having certain dimensions to pass. A restricted passage geometry is, for example, a tunnel, a bridge over a road, an underpass or an entrance into an inner yard or a parking garage.

In a first operation of the method, a sensor value relating to the transportation vehicle surroundings is detected. The sensor value is detected by at least one sensor that is designed to detect sensor signals concerning the surroundings of the transportation vehicle. The at least one sensor may be a camera, a lidar sensor, a radar sensor, a sonar, a laser and/or an ultrasonic sensor.

Furthermore, in a further method operation, a restricted passage geometry is identified from the at least one sensor value. Optionally, the at least one sensor value is used to take a distance measurement to identify a restricted passage geometry. Optionally, a restricted passage geometry is identified from the at least one sensor value by image processing for object detection, particularly by deep-learning-based image processing.

The method then involves an extent of the restricted passage geometry being determined on the basis of the at least one sensor value. An extent of the restricted passage geometry within the context of this disclosure may be defined by the internal measurements of the passage geometry. The extent relates to the region of the passage geometry that permits restricted passage. Furthermore, a position of the restricted passage geometry is determined. Optionally, the geographical coordinates of the passage geometry are determined as GPS data.

As a further method operation, the method comprises determining at least one further transportation vehicle having dimensions that exceed the determined extent and/or having a route that leads to the position of the restricted passage geometry. Optionally, dimensions and/or routes of a multiplicity of transportation vehicles are determined on the basis of cooperative awareness messages, CAMs, sent by the multiplicity of transportation vehicles. Optionally, the determined extent is compared with the determined dimensions, and the at least one further transportation vehicle from the multiplicity of transportation vehicles is determined if its dimensions exceed the determined extent. Optionally, the determined position is compared with the determined routes, and the at least one further transportation vehicle from the multiplicity of transportation vehicles is determined if its route leads to the position. In a further operation, the message may be transmitted to the at least one determined further transportation vehicle.

In a further operation of the method, a message concerning the determined extent and position of the restricted passage geometry is generated for output by way of the at least one further transportation vehicle. Furthermore, the method involves the generated message being transmitted to the at least one further transportation vehicle, a server and/or a roadside unit. Optionally, the transmission is effected according to the C-V2X standard or according to the WLAN protocol IEEE 802.11p. Optionally, the transmission is effected using a cooperative awareness message, CAM. Optionally, the message is forwarded from the server and/or the roadside unit to the at least one further transportation vehicle. Optionally, the message is stored by the server and/or the roadside unit. Repeatedly carrying out the disclosed method thus allows an overview of the extent and position of a multiplicity of restricted passage geometries in the surroundings to be created.

The disclosed method ensures that restricted passage geometries are identified by transportation vehicles in good time. The restrictions are identified even if warning signs are absent or concealed. A further benefit of the method is that current extents of restricted passage geometries are detected and transmitted, whereas warning signs always only reflect the value measured at the time of setup. The method furthermore leads to the message being transmitted only to transportation vehicles that are affected by the restricted passage geometry. This saves energy and resources and avoids unnecessary distractions for drivers.

In at least one embodiment of the disclosed method, there is provision for the determining of the extent to comprise the determining of a maximum passage height, a maximum passage width and/or a three-dimensional travel corridor from the at least one sensor value. A maximum passage height or passage width may be an indication of length that must not be exceeded by a height or width of a transportation vehicle to ensure accident-free passage through the restricted passage geometry. The three-dimensional travel corridor may be determined as a negative of the restricted passage geometry. Accident-free passage through the restricted passage geometry is ensured for a transportation vehicle that can travel through the three-dimensional travel corridor without leaving the lateral limits of the corridor.

A further disclosed embodiment relates to a method of a transportation vehicle for transportation vehicle control in traffic situations with restricted passage geometry. As one operation, the method comprises receiving a message from a further transportation vehicle, wherein the message contains the position and extent of a restricted passage geometry. Optionally, the message is generated and transmitted by the further transportation vehicle by a method of a transportation vehicle for environment detection in traffic situations with restricted passage geometry. The message may be a message based on the C-V2X standard or the WLAN protocol IEEE 802.11p. Optionally, the message is received from the further transportation vehicle directly or is received indirectly via a server and/or a roadside unit.

In a further method operation, the extent of the restricted passage geometry is compared with dimensions of the transportation vehicle. In other words, this method operation involves checking whether the transportation vehicle fits through the extent of the restricted passage geometry.

The method furthermore involves a report being generated on the basis of the comparison and being output by way of an output the transportation vehicle. The report may include a notification that it is possible for the transportation vehicle to pass through the restricted passage geometry if the comparison has revealed that the dimensions of the transportation vehicle are less than the extent. Alternatively, the report is not generated and output if the comparison has revealed that the dimensions of the transportation vehicle are less than the extent. The report may include a notification that it is not possible for the transportation vehicle to pass through the restricted passage geometry if the comparison has revealed that the dimensions of the transportation vehicle exceed the extent. The output method or mechanism may be a display, such as, for example, a central display of the transportation vehicle, a display of an electronic device inside the transportation vehicle or a head-up display of the transportation vehicle. The report may be output by way of the output method or mechanism as text and/or a pictorial symbol. Optionally, the report is output by the output method or mechanism as an augmented reality (AR) display overlaid on the real surroundings of the transportation vehicle.

One optional implementation provides for comparing the position of the restricted passage geometry with a current route of the transportation vehicle. Optionally, the comparison involves determining whether the restricted passage geometry lies on the current route of the transportation vehicle. Additionally or alternatively, current dimensions of the transportation vehicle are determined by the transportation vehicle and the extent of the restricted passage geometry is compared with the current dimensions of the transportation vehicle. In other words, a check is performed to ascertain whether the transportation vehicle with its current dimensions fits through the extent of the restricted passage geometry. Optionally, the current dimensions are determined by the transportation vehicle on the basis of current transportation vehicle settings that are read by the transportation vehicle. Optionally, a current width of the transportation vehicle is determined on the basis of a folded-in or folded-out state of the exterior mirrors of the transportation vehicle. Optionally, a current height of the transportation vehicle is determined on the basis of a current chassis setting of the transportation vehicle. More probably, the current dimensions are determined on the basis of a user input. The user input may contain information relating to at least one accessory that is on the transportation vehicle.

The comparison is furthermore taken as a basis for generating and outputting a report for an output method or mechanism of the transportation vehicle. The report may include a notification that it is possible for the transportation vehicle to travel onward without risk if the comparison has revealed that the current dimensions of the transportation vehicle are less than the extent and/or the restricted passage geometry does not lie on the current route. Alternatively, the report is not generated and output if the comparison has revealed that the current dimensions of the transportation vehicle are less than the extent and/or the restricted passage geometry does not lie on the current route. The report likewise may include a notification that it is not possible for the transportation vehicle to travel onward without risk if the comparison has revealed that the current dimensions of the transportation vehicle exceed the extent and the restricted passage geometry lies on the current route. Optionally, if the comparison has revealed that the restricted passage geometry lies on the current route, the transportation vehicle looks for at least one alternative route. The at least one alternative route may be compared with an overview of a multiplicity of restricted passage geometries that are in the surroundings, which overview is stored on a server and/or a roadside unit. Optionally, no restricted passage geometry whose extent is less than the dimensions of the transportation vehicle lies on the at least one alternative route. Optionally, the report additionally includes advice of at least one alternative route.

At least one disclosed embodiment comprises determining at least one transportation vehicle setting that is relevant to the current dimensions of the transportation vehicle. Optionally, at least one transportation vehicle setting is determined that increases the current dimensions of the transportation vehicle compared to further possible settings of the transportation vehicle, such as, for example, folded-out exterior mirrors, a chassis setting that increases the transportation vehicle height, or an accessory that is on the transportation vehicle. An accessory may be a trailer or a structure of the transportation vehicle. Optionally, a change in the relevant transportation vehicle setting that leads to the dimensions of the transportation vehicle being less than the extent of the restricted passage geometry is furthermore determined.

Optionally, advice concerning the relevant transportation vehicle setting is furthermore output by way of an output method or mechanism of the transportation vehicle. The advice may furthermore include the change in the relevant transportation vehicle setting. In other words, the advice may include a setting that can be made on the transportation vehicle to allow passage through the restricted passage geometry, such as, for example, folding in an exterior mirror, adjusting a chassis setting that reduces the transportation vehicle height, or removing an accessory. Optionally, the relevant transportation vehicle setting is automatically adapted by the transportation vehicle. In other words, the change in the relevant transportation vehicle setting is made automatically by the transportation vehicle itself.

In a further implementation, current dimensions of the transportation vehicle are determined by determining at least one accessory that is on the transportation vehicle and retrieving the dimensions of the at least one accessory from a network server and/or the at least one accessory. Optionally, the at least one accessory that is on the transportation vehicle is determined by methods or mechanisms of at least one sensor that is inherent to the transportation vehicle and/or a user input. Optionally, the at least one accessory is designed for communication with the transportation vehicle and is determined by the communication. Optionally, the dimensions of the at least one accessory are retrieved from a lookup table, LUT, which is stored on a network server and/or in the transportation vehicle itself. Optionally, the dimensions of the at least one accessory are retrieved from an accessory, particularly from the at least one accessory, by the communication.

At least one further disclosed embodiment relates to a transportation vehicle, in particular, a passenger car with an internal combustion, electric or hybrid engine, that is designed to carry out the method of a transportation vehicle for vehicle control in traffic situations with restricted passage geometry. The transportation vehicle comprises a communication module that is designed to receive a message concerning the position and extent of a restricted passage geometry.

Furthermore, the transportation vehicle comprises a control unit that may be designed to determine dimensions of the transportation vehicle, particularly current dimensions of the transportation vehicle, to compare the dimensions with the extent of the restricted passage geometry and to determine a report on the basis of the comparison. The transportation vehicle furthermore comprises an output method or mechanism that is designed to output the report.

In at least one disclosed embodiment, the transportation vehicle is furthermore designed to carry out the above-described method of a transportation vehicle for environment detection in traffic situations with restricted passage geometry. To this end, the transportation vehicle may furthermore comprise a sensor that is designed to detect at least one sensor value relating to the transportation vehicle surroundings.

The control unit may be furthermore designed to identify the restricted passage geometry from the at least one sensor value, to determine the extent of the restricted passage geometry from the at least one sensor value and to determine a position of the restricted passage geometry. The communication module may be furthermore designed to transmit a message concerning the extent and position of the restricted passage geometry to a further transportation vehicle, a server and/or a roadside unit. In other words, the control unit and therefore the transportation vehicle are likewise designed to carry out the above-described method for environment detection in traffic situations with restricted passage geometry.

In another exemplary embodiment of the transportation vehicle, the control unit is furthermore designed to determine at least one transportation vehicle setting that is relevant to the current dimensions of the transportation vehicle. Furthermore, the control unit may be designed to output advice concerning the relevant transportation vehicle setting by way of the output method or mechanism of the transportation vehicle and/or to automatically adapt the relevant transportation vehicle setting.

A further disclosed embodiment relates to a computer program comprising instructions that, when the program is executed by a computer, such as, for example, a control unit of a transportation vehicle, cause the computer to perform the method of a transportation vehicle for environment detection in traffic situations with restricted passage geometry, as described above.

A further disclosed embodiment relates to a computer-readable storage medium comprising instructions that, when executed by a computer, such as, for example, a control unit of a transportation vehicle, cause the computer to perform the method of a transportation vehicle for environment detection in traffic situations with restricted passage geometry, as described above.

A further disclosed embodiment relates to a computer program comprising instructions that, when the program is executed by a computer, such as, for example, a control unit of a transportation vehicle, cause the computer to perform the method of a transportation vehicle for vehicle control in traffic situations with restricted passage geometry, as described above.

A further disclosed embodiment relates to a computer-readable storage medium comprising instructions that, when executed by a computer, such as, for example, a control unit of a transportation vehicle, cause the computer to perform the method of a transportation vehicle for vehicle control in traffic situations with restricted passage geometry, as described above.

Further embodiments become apparent from the other features cited in the subclaims.

The various embodiments and implementations that are cited in this application may, unless explained otherwise in individual cases, be combinable with one another.

FIG. 1 shows a schematic flowchart for an illustrative implementation of a method for environment detection in traffic situations with restricted passage geometry.

In a first operation at S1, at least one sensor is used to detect at least one sensor value relating to the transportation vehicle surroundings. A second operation at S2 involves identifying a restricted passage geometry, in particular, a bridge or a tunnel, from the at least one sensor value detected in the first operation at S1.

In a third operation at S3, an extent of the restricted passage geometry is determined on the basis of the at least one sensor value detected in the first operation at S1, and a position of the restricted passage geometry is determined. In this case, the extent is determined as a maximum passage height and a maximum passage width of the restricted passage geometry, and the position is determined as geographical coordinates of the passage geometry as GPS data.

From the extent and position of the restricted passage geometry that have been determined in the third operation at S3, a message for output by way of at least one further transportation vehicle is generated in a fourth operation at S4. The at least one further transportation vehicle is determined as a transportation vehicle that is affected by the restricted passage geometry, that is to say whose dimensions exceed the extent or whose route leads to the position.

In a fifth operation at S5, the message generated in the fourth operation at S4 is then transmitted to the at least one further transportation vehicle, in particular, by C-V2X or WLANp communication and directly or via a server or a roadside unit.

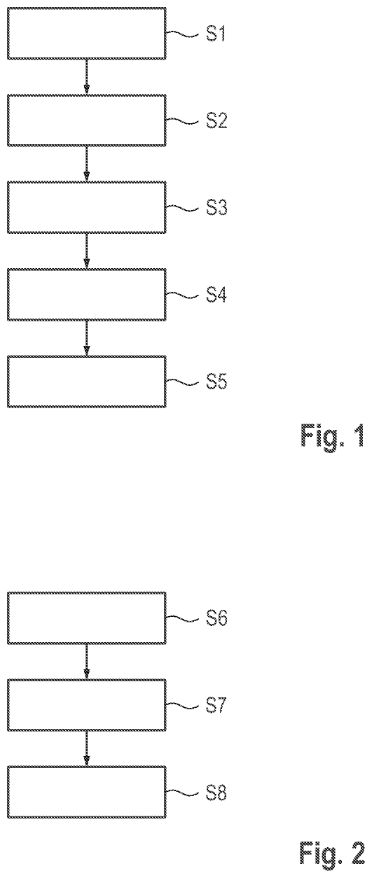

FIG. 2 shows a schematic flowchart for an illustrative implementation of a method for transportation vehicle control in traffic situations with restricted passage geometry.

In a sixth operation at S6, the transportation vehicle receives a message that contains the position and extent of a restricted passage geometry. The message is received from a further transportation vehicle and is the message generated in the fourth operation at S4 and transmitted in the fifth operation at S5.

The extent of the restricted passage geometry is then compared with dimensions of the transportation vehicle in a seventh operation at S7. The dimensions are current dimensions of the transportation vehicle that are determined by the transportation vehicle itself. Additionally, the position is compared with a current route of the transportation vehicle. Furthermore, a transportation vehicle setting that is relevant to the current dimensions is determined.

In an eighth operation at S8, a report is generated on the basis of the comparisons that have been carried out and is output by way of an output method or mechanism of the transportation vehicle. The report is output in this case because the comparisons carried out in the seventh operation at S7 have revealed that the dimensions of the transportation vehicle exceed the extent and the position lies on the current route of the transportation vehicle. The report contains advice that it is not possible to travel onward on the current route without risk, a description of an alternative route and a transportation vehicle setting that can be made to make it possible to travel through the restricted passage geometry.

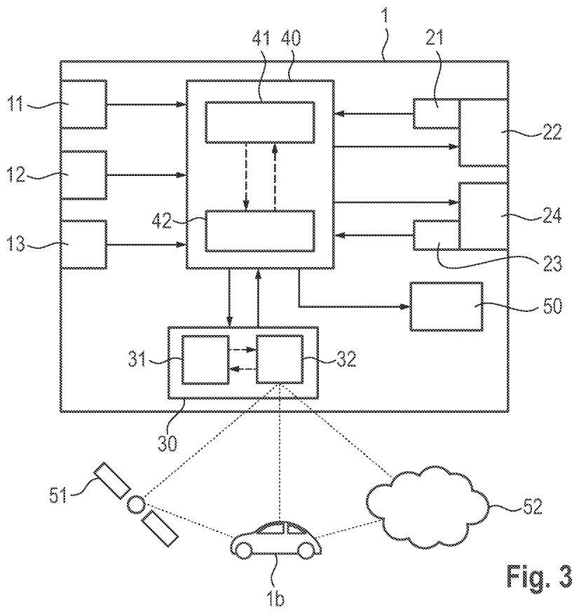

FIG. 3 shows a schematic representation, in particular, a block diagram, of an illustrative transportation vehicle 1, in particular, a two-track transportation vehicle with an internal combustion, electric or hybrid engine. The transportation vehicle 1 is designed to carry out a method for environment detection in traffic situations with restricted passage geometry, as described above and shown in FIG. 1. Furthermore, the transportation vehicle 1 is designed to carry out a method for transportation vehicle control in traffic situations with restricted passage geometry, as described above and shown in FIG. 2.

To this end, the transportation vehicle 1 first has a multiplicity of first sensors, in particular, a first sensor 11, a second sensor 12 and a third sensor 13. The first sensors 11, 12, 13 are configured to capture surroundings data of the transportation vehicle 1 and comprise, for example, a camera for capturing images of the surroundings of the transportation vehicle 1 and/or distance sensors, such as, for example, ultrasonic sensors, for measuring distances from objects surrounding the transportation vehicle 1. The first sensors 11, 12, 13 transmit the sensor values that they have detected relating to the transportation vehicle surroundings to a control unit 40 of the transportation vehicle 1. The control unit 40 is designed to use the sensor values to identify a restricted passage geometry, to determine an extent and position thereof and to generate a message therefrom for output in a second transportation vehicle 1b. To this end, the control unit 40 has an internal memory 41 and a CPU 42 that communicate with one another, for example, via a suitable data bus.

The transportation vehicle 1 furthermore comprises a communication module 30 having a memory 31 and one or more transponders or transceivers 32. The transponder 32 is a radio, WLAN, GPS or BLUETOOTH® transceiver or the like, in particular, a transponder configured for communication in a communication network. The transponder communicates with the internal memory 31 of the communication module 30, for example, via a suitable data bus. The transponder 32 can be used, for example, to determine the current position of the transportation vehicle 1 by way of communication with a GPS satellite 51 and to store the position in the internal memory 31. In addition, the communication module 30 is configured to use V2V communication to communicate with the second transportation vehicle 1b, in particular, also via a communication network 52. Furthermore, the communication module 30 may also be configured for communication with a server of the communication network 52.

The communication module 30 also communicates with the control unit 40. It transmits received data thereto and/or receives data to be sent therefrom. As such, the control unit 40 can use the communication module 30 to transmit the generated message to the second transportation vehicle 1b. Furthermore, the control unit 40 can use the communication module 30 to receive from the second transportation vehicle 1b a message that contains the position and extent of a restricted passage geometry.

The communication network 52 may be a network based on the 3GPP standard, for example, an LTE, LTE-A (4G) or 5G communication network. The communication network may furthermore be designed for the following operations or according to the following standards: High Speed Packet Access (HSPA), a Universal Mobile Telecommunication System (UMTS), UMTS Terrestrial Radio Access Network (UTRAN), evolved-UTRAN (e-UTRAN), Global System for Mobile communication (GSM), Enhanced Data rates for GSM Evolution (EDGE), GSM/EDGE Radio Access Network (GERAN). Alternatively or additionally, the communication network 52 may also be designed according to one of the following standards: Worldwide Inter-operability for Microwave Access (WIMAX) network IEEE 802.16, Wireless Local Area Network (WLAN) IEEE 802.11. Optionally, the communication network 52 uses one of the following encoding methods: Orthogonal Frequency Division Multiple Access (OFDMA), Time Division Multiple Access (TDMA), Code Division Multiple Access (CDMA), a Wideband-CDMA (WCDMA), Frequency Division Multiple Access (FDMA) or Spatial Division Multiple Access (SDMA) etc.

The control unit 40 is furthermore designed to compare the extent of the restricted passage geometry with dimensions of the transportation vehicle 1 and to compare the position with a current route of the transportation vehicle 1. To this end, the control unit 40 can determine current dimensions of the transportation vehicle 1 on the basis of sensor signals from second sensors 21, 23, in particular, a fourth sensor 21, which monitors a first transportation vehicle component 22, and a fifth sensor 23, which monitors a second transportation vehicle component 24. The first transportation vehicle component 22 is an exterior mirror of the transportation vehicle 1, and the control unit 40 can use the first sensor 21 to identify a folded-in or folded-out state of the mirror. The second transportation vehicle component 24 is an adaptive chassis, whose state the control unit 40 can identify by the fifth sensor 23. Furthermore, the control unit 40 can determine a transportation vehicle setting that is relevant to the current dimensions.

The control unit 40 can furthermore generate a report on the basis of the comparison and can output the report by way of an output mechanism 50 of the transportation vehicle 1. The report contains, for example, advice that it is not possible to travel onward on the current route without risk, a description of an alternative route and a transportation vehicle setting that can be made to make it possible to travel through the restricted passage geometry. The transportation vehicle setting can also be adjusted automatically by the control unit 40 as a result of the latter sending actuating signals to the transportation vehicle components 22, 24.

The control unit 40 is thus communicatively connected to at least the first sensors 11, 12, 13, the second sensors 21, 23, the transportation vehicle components 22, 24, the output mechanism 50 and the communication module 30, for example, via one or more respective CAN connections, one or more respective SPI connections or other suitable data connections.

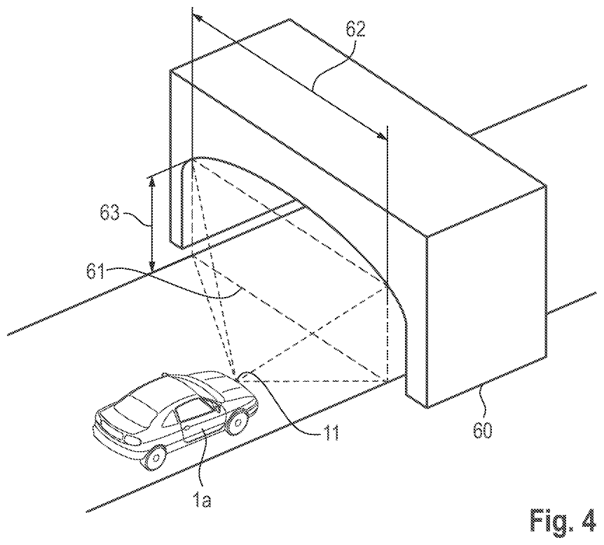

FIG. 4 shows detecting, identifying and determining according to method operations at S1, S2, S3 of an illustrative implementation of a method for environment detection. A first transportation vehicle 1a is shown, which is in front of a restricted passage geometry 60, in particular, in front of a bridge 60, that restricts passage on the road. The transportation vehicle 1a uses a sensor 11 to detect a sensor value and, from the sensor value, identifies a restricted passage geometry 60 having an extent 61. The transportation vehicle 1a is designed to determine the extent 61, in particular, a passage width 62 and a passage height 63 of the extent 61, from the sensor value and to determine a position of the restricted passage geometry 60.

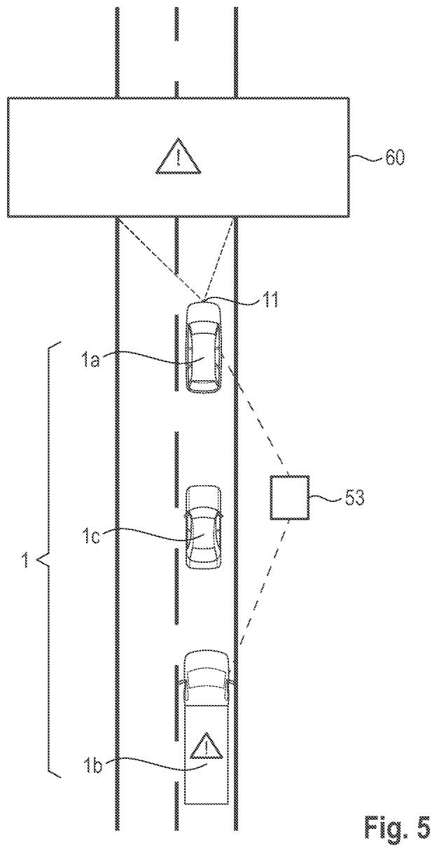

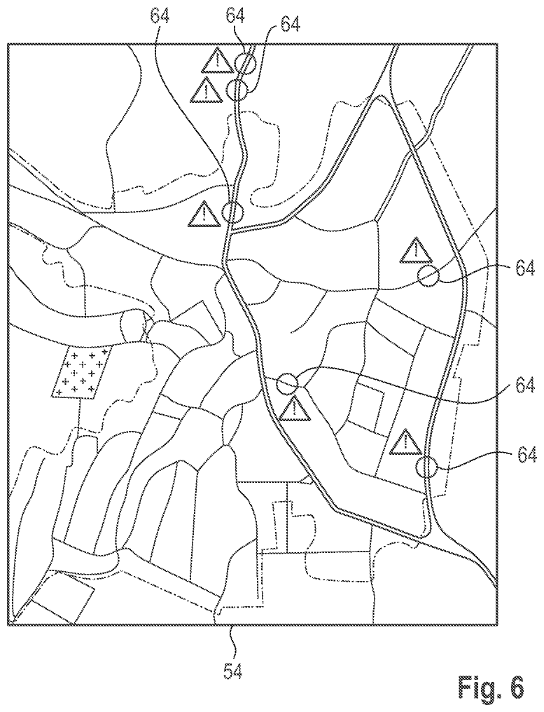

FIG. 5 shows determining, generating and transmitting according to method operations at S3, S4, S5 of an illustrative implementation of a method for environment detection. As shown in a different perspective in FIG. 4, the transportation vehicle 1a takes at least one sensor value of the sensor 11 as a basis for determining the extent 61 and the position of the restricted passage geometry 60. The transportation vehicle then generates a message that concerns the extent 61 and position for output in a further transportation vehicle. The message is then transmitted to the further transportation vehicle, here, in particular, a second transportation vehicle 1b. In this illustrative implementation, the message is sent to a roadside unit 53 and received by the second transportation vehicle 1b from the roadside unit 53. The transmitting carried out in this way is represented by the finely dashed lines. The message is additionally stored by the roadside unit 53, and a multiplicity of messages are taken as a basis for generating an overview of positions 64 and extents 61 of a multiplicity of restricted passage geometries 60 in the surroundings 54, which is represented pictorially in FIG. 6.

In the case shown in FIG. 5, the extent is received by the second transportation vehicle 1b and not by a third transportation vehicle 1c. The second transportation vehicle 1b here is a truck that has dimensions that exceed the extent 61 and whose route leads to the position 64. The second transportation vehicle 1b is thus affected by the restricted passage geometry 60. The message is therefore transmitted to the second transportation vehicle 1b to allow an output by the second transportation vehicle 1b that is based on the message, the output being described in detail below. The third transportation vehicle 1c here is a passenger car having smaller dimensions, which means that the restricted passage geometry 60 is not relevant to the third transportation vehicle 1c. The disclosed method thus leads to the driver of the third transportation vehicle 1c not being able to be distracted by an output, based on the extent 61, that does not concern him.

The second transportation vehicle 1b compares the extent 61 of the restricted passage geometry 60 with current dimensions of the transportation vehicle 1b and compares the position 64 with its current route. Furthermore, the transportation vehicle 1b determines a transportation vehicle setting that is relevant to the current dimensions.

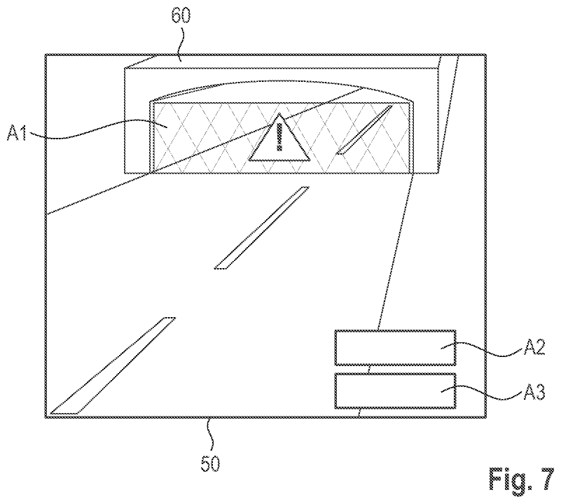

The transportation vehicle 1b then generates a report on the basis of the comparison and outputs the report by way of an output mechanism 50. The output A1, A2, A3 by the transportation vehicle 1b is shown in FIG. 7 according to an illustrative implementation of the described method. The depiction is of an output mechanism 50, in particular, a head-up display, of the second transportation vehicle 1b. In front of the transportation vehicle 1b is the restricted passage geometry 60. The comparison carried out has revealed that the dimensions of the transportation vehicle exceed the extent and the position 64 lies on the current route of the transportation vehicle. The report therefore contains in particular, advice that it is not possible to travel onward on the current route without risk, which is output as a first output A1 by augmented reality, AR. The first output A1 is colored red and provided with a warning symbol, in particular, as a representation of the extent 61.

A second output A2 furthermore includes a report that describes a determined alternative route. The alternative route was generated on the basis of the overview shown in FIG. 6, which means that none of the restricted passage geometries 60, whose extents are less than the dimensions of the second transportation vehicle 1b, lie on the alternative route. In the case shown in FIG. 7, a transportation vehicle setting, in particular, a setting of an adaptive chassis, that would reduce the height of the transportation vehicle 1b and thus allow passage is additionally determined. The determined setting is taken as a basis for outputting a third output A3. The driver of the second transportation vehicle 1b learns from the output A1, A2, A3, quickly and in a clearly laid-out manner, that it is not possible to travel through the restricted passage geometry 60 without risk, and can decide whether he wishes to use the alternative route or wishes to adapt the transportation vehicle setting.

### LIST OF REFERENCE SIGNS

1 transportation vehicle
1a first transportation vehicle
1b second transportation vehicle
1c third transportation vehicle
11 first sensor
12 second sensor
13 third sensor
21 fourth sensor
22 first transportation vehicle component
23 fifth sensor
24 second transportation vehicle component
30 communication unit
31 internal memory
32 transceiver
40 control unit
41 internal memory
42 CPU
50 output mechanism
51 satellite
52 network
53 roadside unit
54 surroundings
60 restricted passage geometry
61 extent
62 passage width
63 passage height
64 position
A1 first output
A2 second output
A3 third output
S1 first method operation
S2 second method operation
S3 third method operation
S4 fourth method operation
S5 fifth method operation
S6 sixth method operation
S7 seventh method operation
S8 eighth method operation

1. A transportation vehicle comprising:
a communication module to receive a message concerning the position and extent of a restricted passage geometry and to send a message concerning the dimensions and route of the transportation vehicle;
a control unit to determine dimensions of the transportation vehicle, to compare the dimensions of the transportation vehicle with the extent of the restricted passage geometry, and to determine a report based on the comparison; and
an output display to output the report.

2. The transportation vehicle of claim 1, further comprising at least one sensor to detect at least one sensor value relating to the transportation vehicle surroundings,
wherein the control unit identifies the restricted passage geometry from the at least one sensor value, determines the extent of the restricted passage geometry from the at least one sensor value, and determines a position of the restricted passage geometry, and
wherein the communication module transmits a message concerning the extent and position of the restricted passage geometry to a further transportation vehicle, a server and/or a roadside unit.

3. The transportation vehicle of claim 1, wherein the control unit determines at least one transportation vehicle setting that is relevant to the current dimensions of the transportation vehicle and outputs advice concerning the relevant transportation vehicle setting by the output display of the transportation vehicle and/or to automatically adapt the relevant transportation vehicle setting.

4. A method of a transportation vehicle for environment detection in traffic situations with restricted passage geometry, the method comprising:
detecting at least one sensor value relating to the transportation vehicle surroundings by using at least one sensor;
identifying a restricted passage geometry from the at least one sensor value;
determining a position of the restricted passage geometry and an extent of the restricted passage geometry based on the at least one sensor value;
determining at least one further transportation vehicle having dimensions that exceed the determined extent and/or a route that leads to the position of the restricted passage geometry;
generating a message concerning the determined extent and position of the restricted passage geometry for output by the at least one further transportation vehicle; and
transmitting the message to the at least one further transportation vehicle, a server and/or a roadside unit.

5. The method of claim 4, wherein the determining of the extent comprises determining a maximum passage height, a maximum passage width, and/or a three-dimensional travel corridor from the at least one sensor value.

6. A method of a transportation vehicle for vehicle control in traffic situations with restricted passage geometry, the method comprising:
sending a message containing information relating to dimensions and a route of the transportation vehicle to a further transportation vehicle;
receiving a message containing the position and extent of a restricted passage geometry from the further transportation vehicle;
comparing the extent of the restricted passage geometry with the dimensions of the transportation vehicle; and
generating and outputting a report by an output display of the transportation vehicle based on the comparison.

7. The method of claim 6, further comprising:
comparing the position of the restricted passage geometry with a current route of the transportation vehicle; and
taking the comparison as a basis for adapting the route; and/or
determining current dimensions of the transportation vehicle by the transportation vehicle.

8. The method of claim 7, further comprising:
determining at least one transportation vehicle setting that is relevant to the current dimensions of the transportation vehicle; and
outputting advice concerning the relevant transportation vehicle setting by an output display of the transportation vehicle; and/or
automatically adapting the relevant transportation vehicle setting by the transportation vehicle.

9. The method of claim 7, further comprising:
determining current dimensions of the transportation vehicle by determining at least one accessory that is on the transportation vehicle; and
retrieving the dimensions of the at least one accessory from a network server and/or at least one accessory.
